(19) United States
(12) Patent Application Publication
(10) Pub. No.: US 2009/0165535 A1
(43) Pub. Date: Jul. 2, 2009

(54) LEAK LOCALIZATION IN A CAVITATED BODY

(76) Inventors: Douglas E. Adams, West Lafayette, IN (US); Muhammad Haroon, Braunschweig (DE); Mandar Deo, Columbus, IN (US)

Correspondence Address: BOSE MCKINNEY & EVANS LLP, 111 MONUMENT CIRCLE, SUITE 2700, INDIANAPOLIS, IN, 46204, US

(21) Appl. No.: 12/266,035

(22) Filed: Nov. 6, 2008

Related U.S. Application Data
(60) Provisional application No. 60/985,665, filed on Nov. 6, 2007.

(51) Int. Cl. G01M 3/04

(52) U.S. Cl. 73/49.7

(57) ABSTRACT

The present invention includes a method and system using dynamic pressure measurements for determining a presence, location, and size of a leak in a chamber of a body. The method includes sealing a plurality of ports of the chamber, pressurizing the chamber with a fluid, measuring a dynamic pressure at each of the plurality of ports, and analyzing the dynamic pressure measured at each of the plurality of ports to determine a presence, location, and/or size of the leak. The location of the leak can be determined by analyzing magnitude and/or phase values from a generated frequency response function matrix, interpolating between two of the plurality of ports, triangulating between three of the plurality of ports, and/or analyzing a rate and profile at which the pressure decays at each of the plurality of ports to determine the location of the leak.

### RELATED APPLICATIONS

This application claims priority to U.S. Provisional Patent Application No. 60/985,665, filed Nov. 6, 2007, which is hereby incorporated by reference.

### BACKGROUND

The present invention relates generally to a method for detecting leaks, and more particularly to a method for detecting, locating, and quantifying leaks in a chamber of a body.

The detection of leaks in oil and water circuits due to voids or cracks in manufactured castings has presented challenges to engine manufacturers, transmission manufacturers, casting suppliers and others. Many manufacturers and businesses have used various methodologies for detecting such leaks. For example, one method for detecting leaks in a fluid circuit of an engine block has been to seal all ports in the circuit and pressurize the circuit internally. The ability of the circuit to hold pressure without leaking above a predetermined threshold is then evaluated. However, the current method does not locate a leakage path within the circuit. Instead, once a leak has been detected, a manual troubleshooting process is typically initiated that can be expensive and time-consuming. This troubleshooting process, for example, may involve using a dye penetrant to search for voids in the casting of the engine block. Generally, the dye penetrant follows the flow of a fluid such as a gas or liquid through voids or cracks in the casting and the location of the leak can thereby be found by tracking the path traveled by the dye penetrant.

The problem, however, with using a dye penetrant is that often the path traveled by the dye penetrant is contaminated or obscured by a different gas or fluid within the casting. For example, in an oil circuit of the engine block, oil can contaminate and/or obscure the traveled path of the dye penetrant. Additionally, dye penetrants can be difficult to handle and inconvenient to use when attempting to detect a leak in a manufacturing plant or test stand. Shutting down a test stand, for instance, to use a dye penetrant for locating a detected leak can be impractical and time consuming.

Other leak detection methods include sealing all ports of a casting or cavitated body, dipping the casting or cavitated body into a tank of water, pressurizing an internal circuit within the casting or cavitated body, and searching for one or more gaseous bubbles that derive from a leak in the circuit. However, this method of leak testing can typically only indicate whether a leak is present, and does not locate the leak. Also, the time it takes to perform this type of leak test can be substantial, especially when a leak is found in a large device such as an assembled engine. Since this particular method often does not locate the leak, the large device may have to be disassembled before the leak can be found. As a result, manufacturing costs can be significantly affected by trying to detect and locate leaks via this method.

Therefore, what is needed is a method and system for detecting a leak in a chamber of a device and identifying the location and size of the leak by overcoming the shortcomings of the prior art.

### SUMMARY OF THE INVENTION

The present invention provides a method and system for detecting a leak in a chamber of a body or casting. In one exemplary embodiment, the method includes providing an engine system or a portion thereof that has a chamber and inducing a fluid pressure response in the chamber to test for a breach in a boundary of the chamber. The method also includes measuring a dynamic pressure at each of a plurality of pressure measurement sites in the chamber and determining a location of a leak through the boundary of the chamber based on the dynamic pressure at each of the plurality of pressure measurement sites. This method can further include determining the size of the leak and that the leak is present in response to the leak having a size greater than a threshold. The size of the leak can include a value determined by a volume that leaks per unit of time at a specified pressure differential between the chamber and a surrounding environment.

The method can also include producing a frequency response function matrix from the dynamic pressure at each of the plurality of pressure measurement sites. The location of the leak can then be determined by analyzing the phase and/or magnitude from the frequency response function matrix, interpolating between two of the plurality of pressure measurement sites, triangulating between three of the plurality of pressure measurement sites, and/or analyzing a rate and profile at which the pressure decays at each of the plurality of pressure measurement sites to determine the location of the leak. Advantageously, because this method can detect and locate a leak in a single chamber of a body or casting, manufacturing and/or production costs can be reduced while enhancing product quality. The resulting design and manufacturability process can provide long-term improvements to address systemic casting defects.

In a different embodiment, a method is provided to detect, locate, and quantify a leak in a cavitated body having a plurality of ports such as an engine block or engine assembly. The method includes sealing the plurality of ports and pressurizing the cavitated body. The method further includes measuring a dynamic pressure at one or more of the plurality of ports for a period of time and analyzing the measured dynamic pressure to determine a presence, location, and size of the leak. The presence of the leak can be determined in response to the leak having a size greater than a threshold.

Additionally, the method can include a step of producing a frequency response function matrix from the measured dynamic pressures. The location of the leak can then be determined by analyzing the phase and/or magnitude values from the frequency response function matrix, interpolating between two of the plurality of measured dynamic pressures, triangulating between three of the plurality of measured dynamic pressures, and/or analyzing a rate and profile at which the pressure decays at each of the measured dynamic pressures to determine the location of the leak. The presence of the leak can also be determined by analyzing relative magnitude values from the frequency response function matrix.

In another embodiment, a leak detection service method includes providing a leak detection apparatus for detecting and locating a leak in a device having a chamber. The device can be an engine, engine block, or other device having a chamber. The leak detection apparatus can include a fluid pressure response inducer, a plurality of pressure sensors, and a controller. The method includes connecting the leak detection apparatus to the device such that the fluid pressure response inducer and the plurality of pressure sensors are in fluid communication with the chamber. The chamber is substantially sealed and a fluid pressure response is induced in the chamber. The controller can receive dynamic pressure data from the plurality of pressure sensors in response to the induced fluid pressure response and determine a leak location according to the dynamic pressure data.

The controller can produce a frequency response function matrix from the dynamic pressure at each of the plurality of sensors. The location of the leak can be determined by analyzing the phase and/or magnitude values from the frequency response function matrix, interpolating between two of the pressure sensors, triangulating between three of the plurality of pressure sensors, and/or analyzing a rate and profile at which the pressure decays at each of the plurality of pressure sensors to determine the location of the leak. The leak detection service method can also provide output data structured to display the presence, location, and size of the leak.

In an alternative embodiment, a system for determining a location of a leak includes an engine related device, e.g., an engine block, having a substantially sealed chamber, a fluid pressure response inducer and a plurality of pressure sensors being in fluid communication with the chamber, and a controller. The fluid pressure response inducer can be a pump or other fluid supply device that can induce a fluid pressure response in the chamber. The controller can be configured to receive dynamic pressure data from the plurality of pressure sensors in response to the induced fluid pressure response and determine a location of a leak according to the dynamic pressure data. The controller is also configured to produce a frequency response function matrix from the dynamic pressure at each of the plurality of pressure sensors. Accordingly, the controller can then determine the location of the leak by analyzing the phase and/or magnitude values from the frequency response function matrix, interpolating between two of the plurality of pressure sensors, triangulating between three of the plurality of pressure sensors, and/or analyzing a rate and profile at which the pressure decays at each of the plurality of pressure sensors to determine the location of the leak.

The embodiments of the present invention are also advantageous because the method and system can be implemented into an existing test stand and used for detecting, locating, and quantifying leaks in engine blocks and other devices that have a chamber. The detection and location of the leak can be determined by analyzing magnitude and phase values of a frequency response function, interpolating between two pressure measurement locations, triangulating between three pressure measurement locations, or analyzing a rate and profile at which pressure decays at one or more pressure measurement locations within the chamber of, for example, an engine block. Furthermore, a lumped parameter model of an oil or water circuit leak can be used to detect, locate, and quantify an existing leak in an engine block or engine assembly.

Besides engine blocks, other types of blocks or cavitated bodies could benefit from any of the embodiments. While one or more of the methods can detect leaks in an engine block, they can also advantageously be used to detect, locate, and quantify leaks at the system level such as when an engine is being assembled. Also, one or more of the embodiments can be used earlier in the machining process when ports are drilled and/or tapped in the casting. While one or more of the methods can be performed on engine blocks and assemblies, one of ordinary skill in the art will appreciate the methods can be used with other components and assemblies including transmissions and undercarriages of exhaust systems.

### BRIEF DESCRIPTION OF THE DRAWINGS

The above-mentioned aspects of the present invention and the manner of obtaining them will become more apparent and the invention itself will be better understood by reference to the following description of the embodiments of the invention, taken in conjunction with the accompanying drawings, wherein:

FIG. 1 is a schematic of a testing arrangement for analyzing leaks using dynamic pressure measurements;

FIG. 2 is a schematic of a simplified engine block chamber having a plurality of ports;

FIG. 3 is a first graph of a frequency response function including magnitude and phase values produced from the testing arrangement of FIG. 1;

FIG. 4 is a second graph from a frequency response function produced from the testing arrangement of FIG. 1;

FIG. 5 is a schematic of a two port single circuit;

FIG. 6 is a graph of a frequency response function of magnitude and phase values produced from lumped parameter modeling;

FIG. 7 is a system for locating a leak according to dynamic pressure data; and

FIG. 8 is a flow diagram of a method for determining the presence, location, and size of a leak.

Corresponding reference numerals are used to indicate corresponding parts throughout the several views.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In an exemplary embodiment, the present invention includes a method for using dynamic pressure measurements to determine a presence, location, and size of a leak in a chamber of a body such as an engine-related device. The method includes measuring a dynamic pressure at one or more pressure measurement sites at a boundary of the chamber. During the measurement of dynamic pressures at the one or more pressure measurement sites, the chamber is substantially sealed. Substantially sealed is typically an indication that the signal to noise ratio of leakage through a minimal detection size leak (i.e., signal leakage) relative to leakage through a partially or incompletely sealed area of the chamber (i.e., noise leakage) is acceptably high. Where small leaks are to be detected, the sealing should be more complete.

In various embodiments, a chamber of a device having a plurality of ports is sealed as a dynamic pressure is measured at one or more of the plurality of ports. The device can be an engine block, an engine assembly, a casting, a cavitated body, or any other body known to one skilled in the art to which a method for detecting a leak can apply. The method of using dynamic pressure measurements to determine the presence, location, and size of a leak can also include producing a frequency response function matrix and analyzing the magnitude and phase values, interpolating between two of the plurality of ports of the chamber, triangulating between three of the plurality of ports, and/or analyzing a rate and profile at which the pressure decays at each of the plurality of ports.

### Exemplary Model

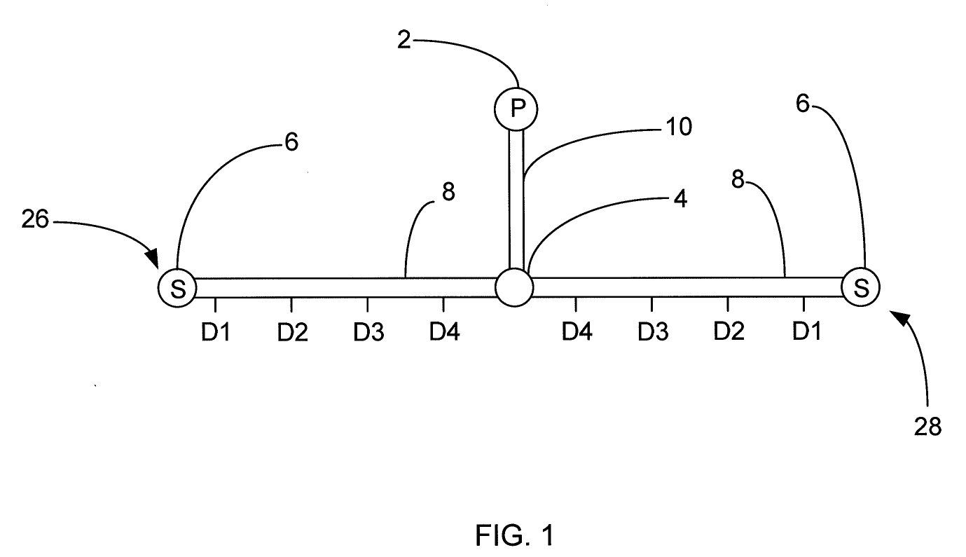

In FIG. 1, a schematic of a model illustrating an aspect of the present invention includes a ⅛″ diameter copper tube 8, both ends 26, 28 of which are sealed, and pressure sensors 6 coupled to both ends of the tube 8. The pressure sensors 6 in FIG. 1 are PCB model number 106B sensors manufactured by PCB Piezotronics, Inc. of Depew, N.Y., although in other aspects different pressure sensors can be used as would be understood by one of ordinary skill in the art. Near the middle of the copper tube 8, a T-fitting 4 connects one end of a supply line 10 to the copper tube 8. A pump or other pressure source 2 is connected to the other end of the supply line 10 for supplying fluid pressure to the copper tube 8. Also, the copper tube 8 includes eight 1/16″ diameter holes drilled therein along the length of the tube 8 at defined locations. In the tube 8 shown in FIG. 1, D1 is disposed approximately 2″ from the pressure sensor 6 at both ends 26, 28 of the tube 8. Likewise, D2 is disposed approximately 10″, D3 is disposed approximately 18″, and D4 is approximately 35″ from the pressure sensor 6 at both ends 26, 28 of the tube 8. During experimental testing, the holes at D1, D2, D3, and D4 were sealed by tape and the tube 8 was pressurized at about 30 psi to simulate pressurizing an engine block casting.

To create a leak in the model, a pin or thumb tack was used to puncture a small hole in the tape that covered one of the holes in the tube 8. This test was repeated a total of eight times so that a leak was created at each of the eight locations along the tube. The dynamic pressure was measured at both ends 26, 28 of the tube 8 during each test by the pressure sensors 6 and several methods were used to determine the presence, location, and size of the leak. A frequency response function matrix for each of the dynamic pressure measurements was produced and compared to the results of a preliminary lumped parameter model of a similar circuit. Each of the different methods of analyzing the leak will now be described in more detail.

### Dynamic Pressure Measurements

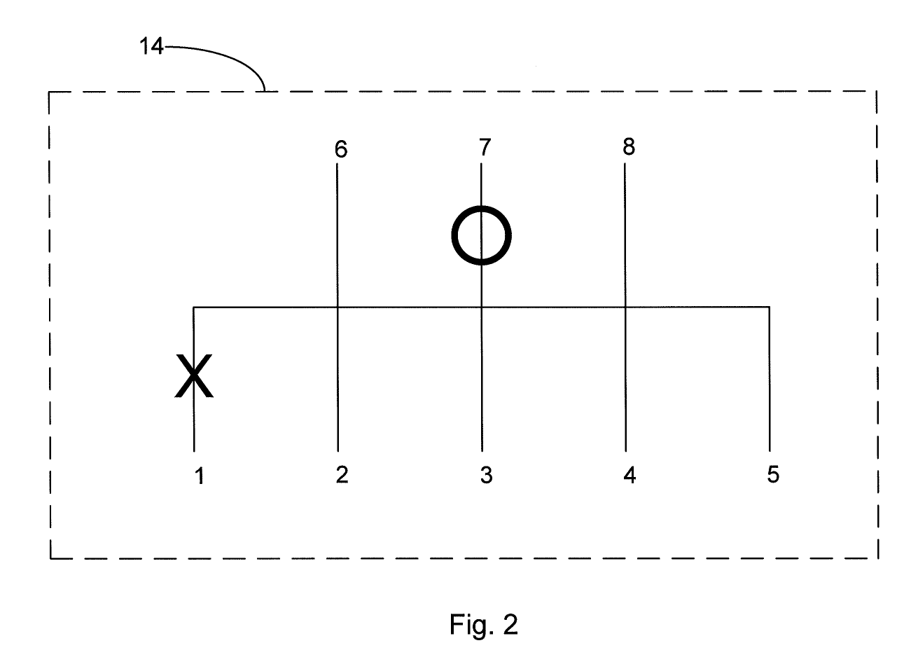

An embodiment of a chamber of a device such as a cavitated body or casting is shown in FIG. 2. The chamber 14 (shown in phantom) includes a plurality of ports, each of which is numbered in FIG. 2 between 1-8. At each of the ports, two variables can be derived: pressure and volumetric velocity (p and q in the pneumatic context). The dynamic nature of these two variables throughout the chamber can be used to locate leaks therein.

As described above with reference to FIG. 1, a pneumatic source such as a pump can be used to pressurize the sealed chamber. Pressure sensors connected to each of the plurality of ports can be used to measure the dynamic pressure over a period of time. If, for example, fluid pressure is applied and the chamber does not leak, the measured pressure at each port should be substantially equivalent, thereby indicating the chamber contains little or no leakage. In some embodiments, a threshold can be established such that even though a leak may exist, the leak is considered to be insignificant. In this case, the measured dynamic pressure does not exceed the threshold and therefore the size of the leak is so small that the chamber still passes a pressure test.

In other embodiments, however, if there is a leak, the rate and profile with which the pressure decays at each port can indicate the location of the leakage path. A frequency response function can be generated for the measured dynamic pressure at each of the plurality of ports. Accordingly, the magnitude and phase of each frequency response function can be compared to determine the location of the leak. In FIG. 2, for example, if the X represents a first leak in the chamber 14, then the pressure measured at port 1 will exhibit the greatest dynamic response among the eight measured pressures. The first leak is located closest in proximity to the pressure sensor at port 1, and therefore the phase of the frequency response function of port 1 will correlate with the first leakage path more closely than the phase of the frequency response functions of the other ports. Similarly, if the O in FIG. 2 represents a second leak in the chamber 14, then the pressure measured at port 7 will produce the greatest dynamic pressure response. Likewise, the phase of the frequency response function of port 7 will most closely correlate with the leakage path of the second leak.

The free decay of pressure is equivalent to an initial condition response, which can involve all of the dynamic characteristics of a pneumatic chamber or circuit throughout a frequency range. Advantageously, this measurement process can be completed relatively quickly, such as during a manufacturing process or in a test apparatus already installed on an engine block assembly line at an engine manufacturing facility.

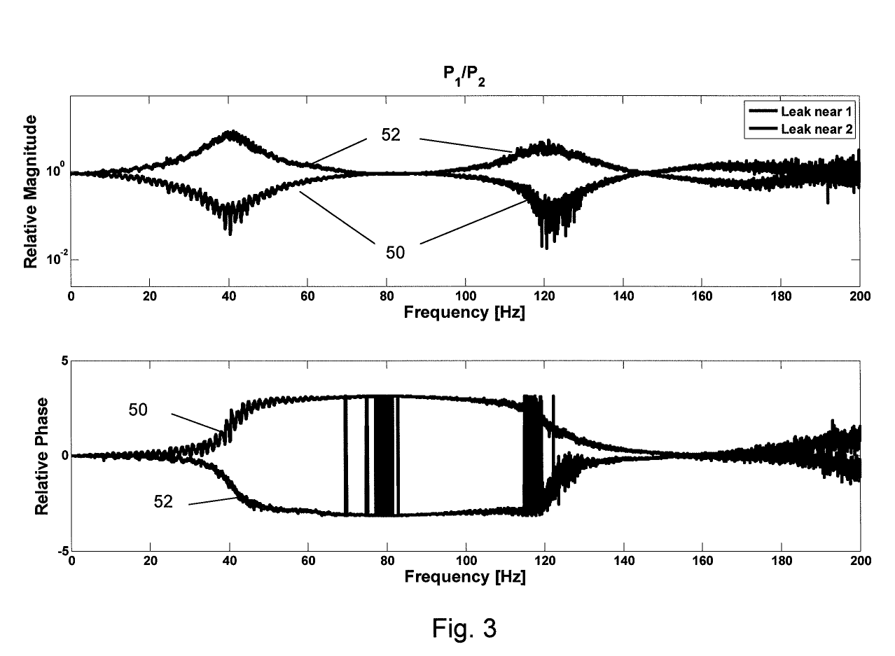

In the embodiment shown in FIG. 1, the frequency response function can be derived from the measured dynamic pressures at both ends 26, 28 of the copper tube 8. The magnitude of the frequency response is typically dependent upon at which end of the copper tube 8 the leak is located. For example, curves of the relative magnitude and phase of the frequency response functions for the first end 26 and second end 28 are illustrated in FIG. 3. For a leak disposed near the first end 26, the curves of the relative magnitude and phase are labeled 50. For a leak disposed near the second end 28, the curves of the relative magnitude and phase are labeled 52. The location of the leak, e.g., closest in proximity to the first end 26 or second end 28 of the tube 8, is correlated to which side of the relative magnitude axis the curve falls on. In FIG. 3, a leak near the first end 26 is identified by the amplitude of curve 50 dipping below the magnitude axis at 10° and a leak near the second end 28 is identified by the amplitude of curve 52 rising above the same magnitude axis.

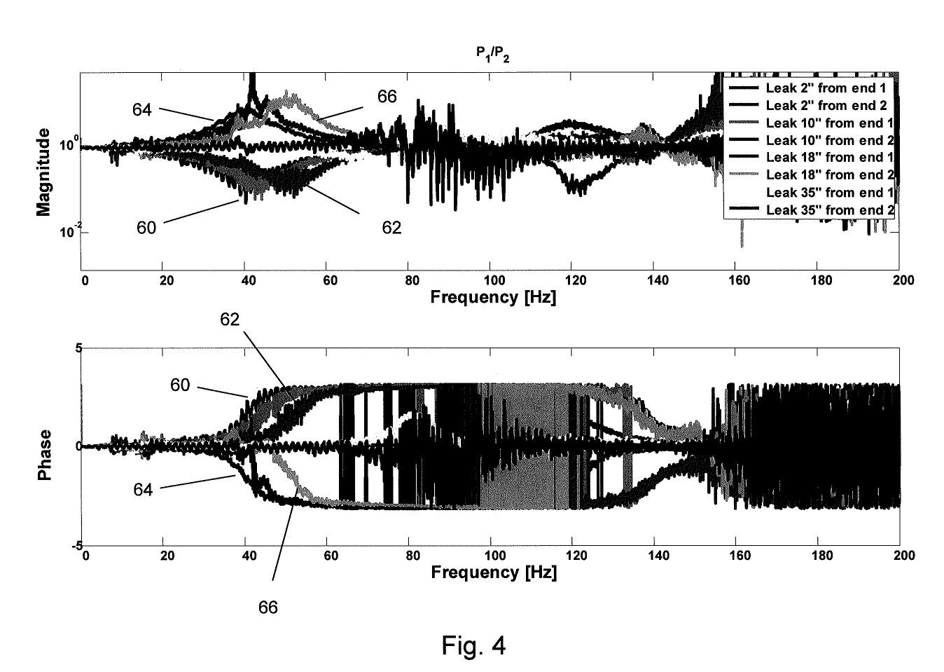

Also, as the location of the leak is moved along the length of the tube, for example from location D1 to location D2, the phase of the frequency response function shifts along the frequency axis. In FIG. 4, for example, the magnitude and phase values of the frequency response function generated at both ends of the copper tube are shown as the location of the leak is shifted along the length of the tube. As described above, the location of eight different 1/16″ holes were drilled into the copper tube at approximately 2″, 10″, 18″, and 35″ from each end of the copper tube. Over the course of eight individual tests, one leak was produced at each location. As the copper tube was pressurized during each test, the dynamic pressure within the tube was measured at both ends and the frequency response function was produced based on the measured dynamic pressure. As illustrated in FIG. 4, the phase shifts as the location of the leak is moved along the length of the tube. For instance, the magnitude and phase of the frequency response function produced for the leak at 18″ from the first end (curve labeled 62) is shifted to the right of the magnitude and phase of the frequency response function produced for the leak at 2″ from the first end (curve labeled 60). Likewise, the magnitude and phase of the frequency response function produced for the leak at 18″ from the second end (curve labeled 66) has shifted to the right of the magnitude and phase of the frequency response function produced for the leak at 2″ from the second end (curve labeled 64). Based at least on the results shown in FIGS. 3 and 4, the location of a leak can be determined from the magnitude and phase values of a frequency response function.

### Triangulation of a Chamber

In another embodiment, triangulation of a chamber, such as for a chamber in an engine assembly or engine block, can also be used to determine the location of a leak in the chamber. In this embodiment, pressure can be measured at two different ports of the chamber. The location of the leak can advantageously be determined through linear interpolation in a single step with only one set of measurements. With multiple measurements in a predefined space, triangulation can be used to determine the location of the leak between two ports of the chamber. While this can be done on an engine stand, one of ordinary skill in the art will also appreciate that this same measurement can be made on other chambers or castings such as in transmissions and undercarriages of exhaust systems.

In certain embodiments, the location of a leak is determined according to the dynamic pressures measured at one or more pressure measurement sites. The location of the leak can be determined by interpolating between a pair of pressure measurements whereby the space between the pressure measurement sites is approximately linear or has a two-dimensional path that is curved. The location can also be determined by interpolating between three measurements whereby the space between the pressure measurement sites has a three-dimensional character. Additional pressure measurement sites can be used in a calculation to increase a confidence value of the location determination or for other purposes. In other embodiments, dynamic pressure values that appear more responsive to a potential leak can be utilized in the calculation, with other dynamic pressure values not utilized in the calculation or utilized with lesser significance.

### Lumped Parameter Model of Circuit

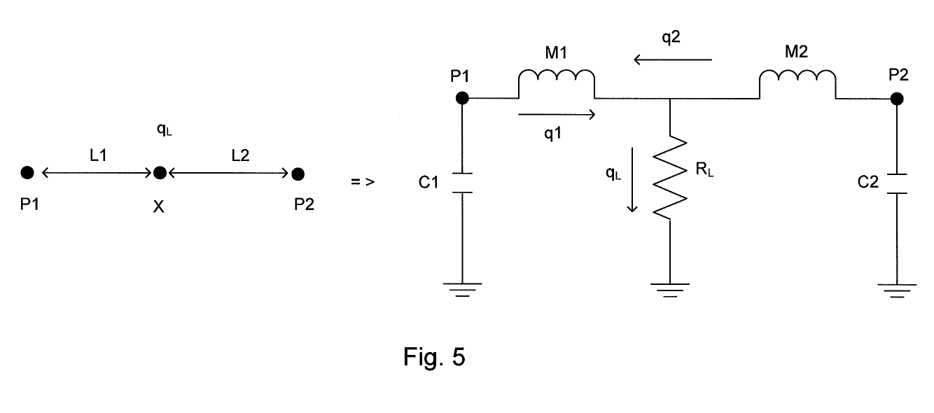

An analytical method for detecting, locating, and quantifying a leak in a circuit of a casting or cavitated body is illustrated in FIG. 5 using a lumped parameter model of the circuit. The lumped parameter model incorporates a single circuit having two ports, P1 and P2. The model shown in FIG. 5 allows for the study of volumetric velocity of flow at a location X between the two ports P1 and P2 and the diameter of various circuits. In the diagram on the left-side of FIG. 5, the distance between location X and P1 in the circuit is defined as distance L1 and the distance between location X and P2 is defined as distance L2. The diagram on the leftside of FIG. 5 can be modeled as a circuit diagram, which is shown on the rightside of FIG. 5. The following equations can be used to derive the different variables in the circuit diagram:

$$\begin{matrix}M = \frac{ρ L}{3 Π {a}^{2}} = 1.39 {e}^{4} kg / {m}^{4} \\ R = \frac{Δ P}{q} \\ C = \frac{V}{γ {P}_{o}} = 2.02 e - 10 {m}^{5} / N\end{matrix}$$

In the circuit diagram, “R” refers to the resistance of fluid flow in the circuit. In other words, at a certain point within the circuit between ports P1 and P2, there is a no slip condition, which is essentially the same as viscous friction acting on a gas or liquid as it flows in the circuit. Therefore, energy is being dissipated as the gas or liquid flows in the circuit.

When a leak is detected, the resistance to flow, R, should be much less than the resistance to leak, R_{L}. The resistance to leak, R_{L}, is a function of the geometry of a crack or void in the casting or cavitated body. In general, quantifying the leak is a function of the pressure decay over a period of time. For example, at each port, the pressure is measured by a sensor and the pressure outside the casting or cavitated body (e.g., of an engine block) is known to be atmospheric pressure. Therefore, the pressure differential between the casting or cavitated body and surrounding environment can be determined. Accordingly, by estimating the volumetric velocity of the leak, the resistance to leak, R_{L}, can be determined as

R_{L}=ΔP/q_{L}

where ΔP is the pressure differential between ports P1 and P2 and q_{L} is the volumetric velocity.

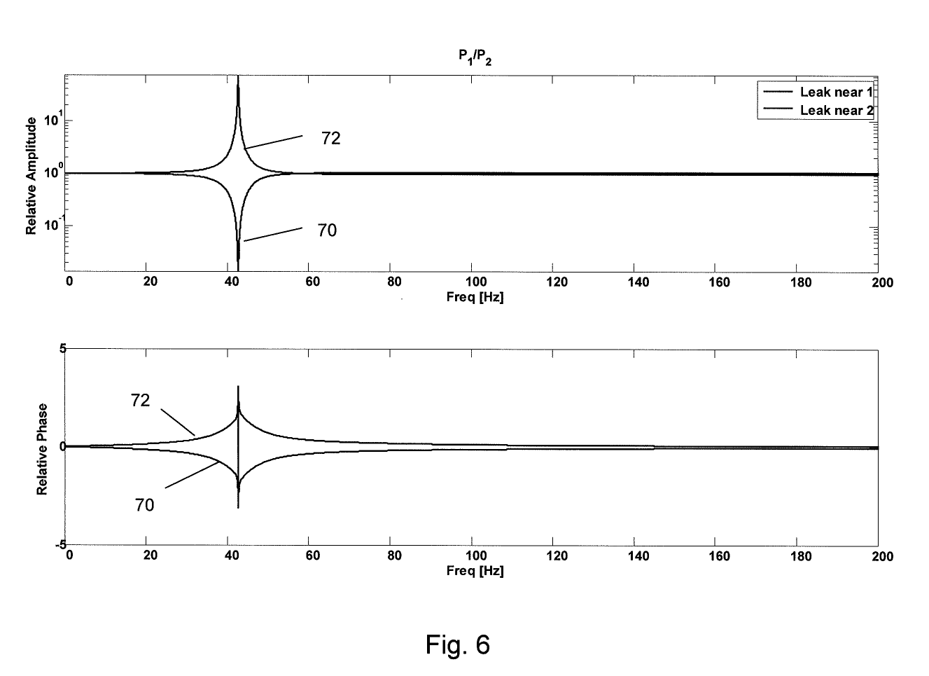

Based on lumped parameter modeling of the circuit shown in FIG. 5, a frequency response function can be produced based on the embodiment of FIG. 1. In FIG. 6, for example, the relative magnitude and phase are shown for a leak being present near the first end 26 and second 28 of the tube 8. A leak near the first end 26 is represented by curve 70 and a leak near the second end is represented by curve 72. Similar trends are apparent between the experimental data shown in FIG. 3 and the analytical data shown in FIG. 6. The relative magnitude of the experimental data in FIG. 3, for example, has a first peak at about 40 Hz and a second peak at about 120 Hz. Likewise, while the analytical data shown in FIG. 6 only has one peak for both the relative magnitude and phase, the relative magnitude has a similar peak at about 40 Hz. From these trends, dynamic pressure measurements can successfully be used to detect, locate, and quantify leaks in a chamber of a casting or cavitated body.

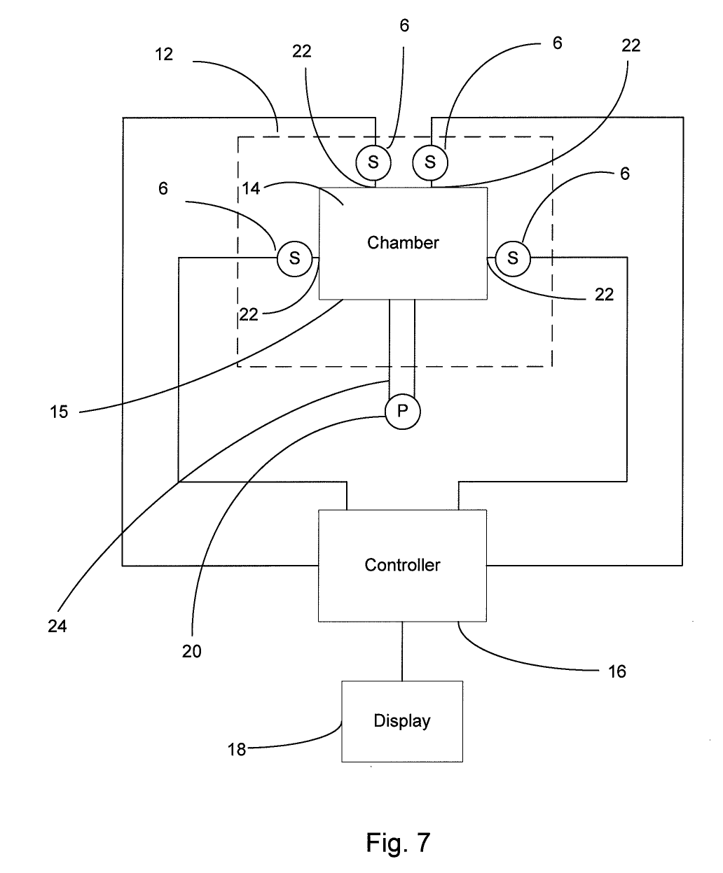

One or more of the above-described methods can be used to detect and locate a leak in an engine block casting or engine assembly. To do so, an embodiment of a leak detection apparatus, as shown in FIG. 7, can be connected to any engine-related device 12 having a chamber 14. The device 12 (shown with phantom lines), for example, can be an engine block, engine assembly, cavitated body, or other casting known to a skilled artisan. The chamber 14, disposed in the device 12, includes a volume defined by an outer boundary or wall 15. The chamber 14 further includes a plurality of ports 22 disposed near the outer boundary or wall 15.

The leak detection apparatus can include a fluid response inducer 20, which can be a pump or other fluid source. The fluid response inducer 20 is connected via a fluid supply line 24 to the chamber 14. The apparatus can also include a plurality of pressure sensors 6 connected to the plurality of ports 22 of the chamber 14. The fluid response inducer 20 and plurality of pressure sensors are in fluid communication with the chamber 14 such that the chamber 14 can be pressurized and the plurality of pressure sensors can measure the pressure at the plurality of ports 22. The types of fluid which can be used to pressurize the chamber include air, water, and oil, although other fluids can be used in other embodiments as understood by one of ordinary skill in the art. The embodiment of the leak detection apparatus shown in FIG. 7 further includes a controller 16 being connected to each of the plurality of pressure sensors 6. The controller 16 can include a user interface such as a keyboard, mouse, or other known user interface. The controller 16 can also include or be connected to a display 18. The display 18, for example, can receive output data, such as the presence, location, and/or size of a leak, from the controller 16 and display the data on a screen of the display 18.

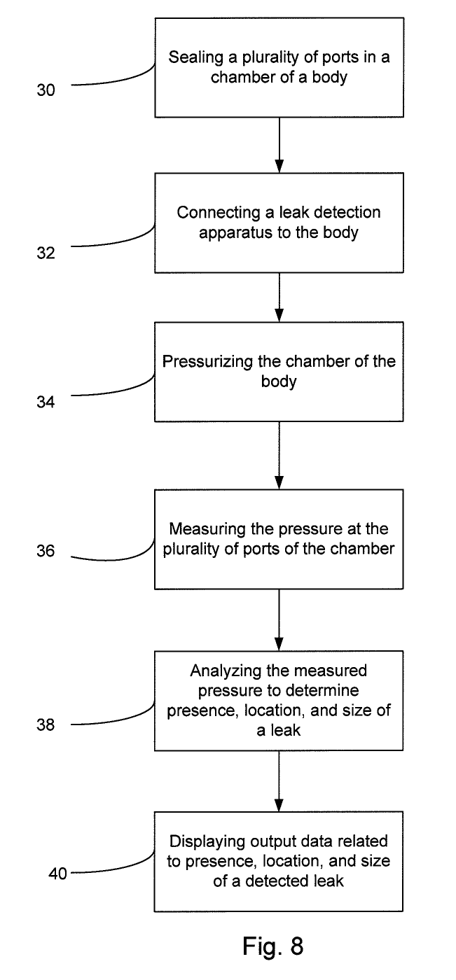

In the embodiment of FIG. 8, a method for detecting a leak includes a step 30 of sealing a plurality of ports in a chamber of a body. The body can be an engine block, engine assembly, casting, cavitated body, or any other body having a chamber known to one of ordinary skill in the art. A second step 32 of the method can include connecting a leak detection apparatus, such as the one shown in FIG. 7, to the body. Referring to FIG. 7, for example, the second step 32 can include connecting the plurality of pressure sensors 6 to the plurality of ports 22 and connecting the fluid response inducer 20 via the fluid supply line 24 to the chamber 14.

After sealing each open port of the chamber, the chamber of the body can be pressurized. In this step 34, the chamber can be pressurized at various pressures. For example, in one embodiment, the chamber is pressurized at 30 psi. In other embodiments, the applied pressure can be selected according to the size of the chamber being pressurized as would be understood by a skilled artisan. Also, the chamber is pressurized for a period of time. For chambers having relatively smaller volumes, the period of time can be less than about 1 minute. For other chambers having larger volumes the period of time can be between about 1-10 minutes. The pressures and periods of time given above are not intended to be limiting, and one skilled in the art can appreciate that different pressures and periods of time can be more advantageous for different chambers and test applications.

Once the chamber is pressurized, the method includes a measuring step 36 and analyzing step 38. In the measuring step 36, the dynamic pressure at each of the plurality of ports of the chamber can be measured by the plurality of pressure sensors of the leak detection apparatus. In the analyzing step 38, the measured dynamic pressure at each of the plurality of ports can be analyzed to determine a presence, location, and/or size of a leak. For example, in the embodiment of FIG. 7, the controller 16 can analyze the measured dynamic pressure at each of the plurality of ports 22 and produce a frequency response function matrix from the dynamic pressure measured by each of the plurality of pressure sensors 6. If a leak is detected, the controller 16 can determine the location of the leak according to one or more of the methods described above. For example, in one embodiment, the controller 16 can determine the location of the leak by analyzing the magnitude and/or phase values from the generated frequency response function matrix. In another embodiment, the controller 16 can determine the location of the leak by interpolating between two of the plurality of pressure sensors. In a different embodiment, the controller 16 can determine the location of the leak by triangulating between three of the plurality of measured dynamic pressures. Alternatively, the controller 16 can analyze a rate and profile at which the pressure decays at each of the measured dynamic pressures to determine the location of the leak. In various embodiments, more than one of these methods can be used to determine the location of the leak.

In certain embodiments, the size of the leak can be determined. The size of a pressure loss anomaly can be utilized to determine the presence of the leak such as, for example, a “leak” below a certain size or threshold may be determined to be an acceptable leak or “non-leak.” In other embodiments, the size of the leak can be determined according to a volume loss per unit of time at a given pressure differential between the chamber and a surrounding environment. The surrounding environment can be any ambient environment and/or a controlled environment.

While the methods and systems have been described relative to an engine-related device, such as an engine block or chamber, a leak can be detected, located, and quantified in any chamber, casting, cavitated body, or the like according to the above-described methods. Likewise, one or more of these methods can be used with transmissions, undercarriages of exhaust systems, and other castings or cavitated bodies known to one of ordinary skill in the art.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for determining a location of a leak, comprising:
providing an engine system or portion thereof including a chamber, the chamber having a boundary and a plurality of pressure measurement sites;
inducing a fluid pressure response in the chamber to test for a breach in the boundary of the chamber;
measuring a dynamic pressure at each of the plurality of pressure measurement sites; and
determining a location of a leak through the boundary of the chamber according to the dynamic pressure at each of the plurality of pressure measurement sites.

2. The method of claim 1, further comprising determining the leak is present in response to the leak having a size greater than a threshold.

3. The method of claim 1, further comprising determining a size of the leak.

4. The method of claim 3, wherein the size of the leak comprises a value determined by a volume leaked per unit of time at a specified pressure differential between the chamber and a surrounding environment.

5. The method of claim 1, wherein the engine system or portion thereof comprises an engine block.

6. The method of claim 1, further comprising producing a frequency response function matrix from the dynamic pressure at each of the plurality of pressure measurement sites, and determining the leak location by at least one analysis step selected from the group consisting of:
analyzing phase values from the frequency response function matrix;
analyzing magnitude values from the frequency response function matrix;
interpolating between two of the plurality of pressure measurement sites;
triangulating between three of the plurality of pressure measurement sites; and
analyzing a rate and profile at which the pressure decays at each of the plurality of pressure measurement sites to determine the location of the leak.

7. The method of claim 1, further comprising producing a frequency response function matrix from the dynamic pressure at each of the plurality of pressure measurement sites, and determining the presence of the leak by analyzing relative magnitude values from the frequency response function matrix.

8. A method for detecting, locating, and quantifying a leak in a cavitated body that includes a plurality of ports, the method comprising:
sealing the plurality of ports in the cavitated body;
pressurizing the cavitated body;
measuring a dynamic pressure at the plurality of ports for a period of time; and
analyzing the measured dynamic pressure to determine a presence, location, and size of the leak.

9. The method of claim 8, further comprising the step of determining the presence of the leak by comparing the measured dynamic pressure to a threshold.

10. The method of claim 8, wherein the cavitated body comprises one of an engine block and an engine assembly.

11. The method of claim 8, further comprising producing a frequency response function matrix from the measured dynamic pressures, and determining the leak location by at least one analysis step selected from the group consisting of:
analyzing phase values from the frequency response function matrix;
analyzing magnitude values from the frequency response function matrix;
interpolating between two of the plurality of measured dynamic pressures;
triangulating between three of the plurality of measured dynamic pressures; and
analyzing a rate and profile at which the pressure decays at each of the measured dynamic pressures to determine the location of the leak.

12. The method of claim 1, further comprising producing a frequency response function matrix from the dynamic pressure at each of the plurality of ports, and determining the presence of the leak by analyzing relative magnitude values from the frequency response function matrix.

13. A leak detection service method, comprising:
providing a leak detection apparatus comprising:
a fluid pressure response inducer;
a plurality of pressure sensors;
a controller;
connecting the leak detection apparatus to a device having a chamber such that the fluid pressure response inducer and the plurality of pressure sensors are in fluid communication with the chamber;
substantially sealing the chamber; and
inducing a fluid pressure response in the chamber;
wherein, the controller is structured to:
receive dynamic pressure data from the plurality of pressure sensors in response to the induced fluid pressure response; and
determine a leak location according to the dynamic pressure data.

14. The method of claim 13, wherein the controller is further structured to produce a frequency response function matrix from the dynamic pressure data, and to determine the leak location by at least one analysis step selected from the group consisting of:
analyzing phase values from the frequency response function matrix;
analyzing magnitude values from the frequency response function matrix;
interpolating between two of the plurality of sensors;
triangulating between three of the plurality of sensors; and
analyzing a rate and profile at which the pressure decays at each of the plurality of pressure sensors to determine the location of the leak.

15. The method of claim 14, further comprising providing output data structured to display the presence and location of the leak.

16. The method of claim 14, wherein the output data is further structured to display a size of the leak.

17. A system, comprising:
an engine related device having a substantially sealed chamber;
a plurality of pressure sensors in fluid communication with the substantially sealed chamber;
a fluid pressure response inducer in fluid communication with the substantially sealed chamber, the fluid pressure response inducer structured to induce a fluid pressure response in the substantially sealed chamber; and
a controller structured to:
receive dynamic pressure data from the plurality of pressure sensors in response to the induced fluid pressure response; and
determine a leak location according to the dynamic pressure data.

18. The system of claim 17, wherein the fluid response inducer comprises a pump.

19. The system of claim 17, wherein the engine related device comprises an engine block.

20. The system of claim 17, wherein the controller is further structured to produce a frequency response function matrix from the dynamic pressure measured by each of the plurality of pressure sensors, and to determine the leak location by at least one analysis step selected from the group consisting of:
analyzing phase values from the frequency response function matrix;
analyzing magnitude values from the frequency response function matrix;
interpolating between two of the plurality of sensors;
triangulating between three of the plurality of sensors; and
analyzing a rate and profile at which the pressure decays at each of the plurality of pressure sensors to determine the location of the leak.

21. A method for determining a presence of a leak in a chamber of a body, the chamber having a plurality of ports, comprising:
sealing the plurality of ports of the chamber;
connecting a plurality of sensors to the plurality of ports;
pressurizing the chamber with a fluid;
measuring a dynamic pressure at each of the plurality of ports for a period of time;
analyzing the dynamic pressure at each of the plurality of ports; and
determining a presence of a leak.

22. The method of claim 21, further comprising producing a frequency response function matrix from the dynamic pressure measured at each of the plurality of ports.

23. The method of claim 22, further comprising locating the leak by at least one analysis step selected from the group consisting of:
analyzing phase values from the frequency response function matrix;
analyzing magnitude values from the frequency response function matrix;
interpolating between two of the plurality of sensors;
triangulating between three of the plurality of sensors; and
analyzing a rate and profile at which the pressure decays at each of the plurality of pressure sensors to determine the location of the leak.

24. The method of claim 21, wherein the body comprises an engine block.

25. The method of claim 21, wherein the determining step comprises determining a size of the leak.

26. The method of claim 25, wherein the leak is present when the size of the leak is greater than a threshold value.

27. The method of claim 25, further comprising determining the chamber is leak-free when the size of the leak is less than a threshold value.
